(19) United States
(12) Patent Application Publication
(10) Pub. No.: US 2006/0145488 A1
(43) Pub. Date: Jul. 6, 2006

(54) Door opener

(76) Inventors: Norman Wittke, Albstadt (DE); Gisbert Failer, Winterlingen (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 10/522,585

(22) PCT Filed: Sep. 15, 2004
(86) PCT No.: PCT/EP04/10351

§ 371 Date: Jan. 30, 2006

(30) Foreign Application Priority Data
Oct. 13, 2003 (DE) 103 47 528.1

(51) Int. Cl. E05B 15/02

(52) U.S. Cl. 292/341.15

(57) ABSTRACT

A door opener is described for releasing a door with a lock catch counterpart for holding a lock catch and with a switchable securing element to secure the door opener against unauthorized opening of the door. The invention is based on the object of further developing this type of known door openers for special application purposes. To do this, the invention provides an ejector for ejecting the lock catch out of the lock catch counterpart, a transfer element for transferring the force initiate through the door to the door opener and an actuating element for actuating the ejector.

The invention relates to a door opener for releasing a door that is provided with a lock catch counterpart and with a controllable securing element for securing the door opener against unauthorized opening of the door.

It is known that door openers are used in the door locking systems of apartment houses and office buildings. In these, a swivel catch used as the lock catch counter part is released or blocked by a blocking lever (change-over), which in turn is secured by the armature of an electromagnet. The lock catch of the door engages behind the swivel catch and when released, the swivel catch can be pressed back and the door can be opened.

For special application situations, in each case adaptations to the required characteristics are necessary so that a series of different door opener types have been developed for different tasks. In this case, it involves noise-critical usage areas, such as hospitals for example. A special usage area is also present if function safety has to be ensured with high preload. Also special thermal conditions and/or special conditions with respect to safety requirements may be present, which under certain circumstances may prevent the use of the known door openers due to non-fulfillment of these conditions.

The object of the invention is to further develop a door opener of the type mentioned at the beginning that is still suitable for the most usage areas objectives possible and is still designed so that it is simple.

This object is achieved in that it is provided with an ejector for ejecting the lock catch from the lock catch counterpart and with a force transmission element between the lock catch counter part and the ejector, with which the force initiated by the lock catch is transferred to the ejector after a deflection.

The basic concept of the invention consists in that the force introduced when pushing the door closed or pulling it open is used through a force-distance conversion to press back a lock catch that is spring-mounted when electromechanical unlocking is carried out. Because of a door opener of this type, it is possible to design the door opening process so that it is free of noise, since the impact energy of the holding element is low and the return noise of the door opener catch is low. Moreover, the engagement of the lock catch by the ejector when the door bounces is reduced. In addition, the functional safety of the door opener is reliably ensured with high pre-load, which can occur due to door gaskets or bimetallic effects caused by temperature fluctuations. Another advantage is that the lock catch counterpart of the door opener can be covered by a closed cover plate. This offers not only visual advantages, but also the door slot can be continuously sealed in the lock area due to the closed cover plate, since the gasket can run all over. In this way, the door opener can also be used for smoke and fire protection doors. In addition, it is advantageous for heat and sound protection. Finally, the closed cover plate achieves a high static holding force. Lastly, the invention is distinguished by a small construction shape so that the door opener can be installed even with small frame widths.

A preferred further development of the invention provides that the ejector has a slider plate and an operating element and the operating element is mounted directly on the lock catch counterpart. Because of this arrangement, there is an optimum introduction of force against the lock catch. In addition it is effective that the operating element is designed as a pin that is mounted so that it can slide lengthwise. In this case, the pin can be arranged in a guide in the lock catch counterpart, which in the simplest case is designed as a drilled hole. The pin itself represents a cost-effective design of the operating element.

In addition, it is advantageous that a pre-stressed element is provided for setting the triggering force that releases the door. Besides that, the transfer element and/or the lock catch counterpart can be prestressed. In this case, a spring is provided for prestressing. The spring force is preferably adjustable here. In this way, the triggering forces can be specified so that variable adaptations to the respective usage conditions and door weights are possible.

It is especially effective that a pressure piece is provided on the lock catch counterpart. The pressure piece can be used to carry out an adjustment of the triggering force.

Another teaching of the invention provides that the transfer element is designed as a change-over. Alternatively the transfer element can be a Bowden cable, multi-link transmission, pushing element chain or hydraulic system. If the change-over has two lever arms, an optimum force transmission can be set. Preferably the lock catch counterpart acts on a short lever arm, while a longer lever arm transfers the force initiated to the actuating element.

Preferably it is also provided that a roller element is present on the lock catch counterpart in the engagement area with the lock catch so that practically no friction, and thus no wear, occurs.

Alternately to the electromagnets used as release reactors for the securing element, the invention also provides the locking and unlocking actuation piezoelectrically, magneto-restrictively, using shape-memory actuators, mechanically, using rheological fluids, hydraulically, pneumatically or with a combination of these methods. With hydraulic, pneumatic and rheological release methods, a so-called function for automatic release of the door opener in an emergency can be implemented.

In the following, the invention will be described in more detail using the embodiment examples shown in the drawings. The following are shown schematically:

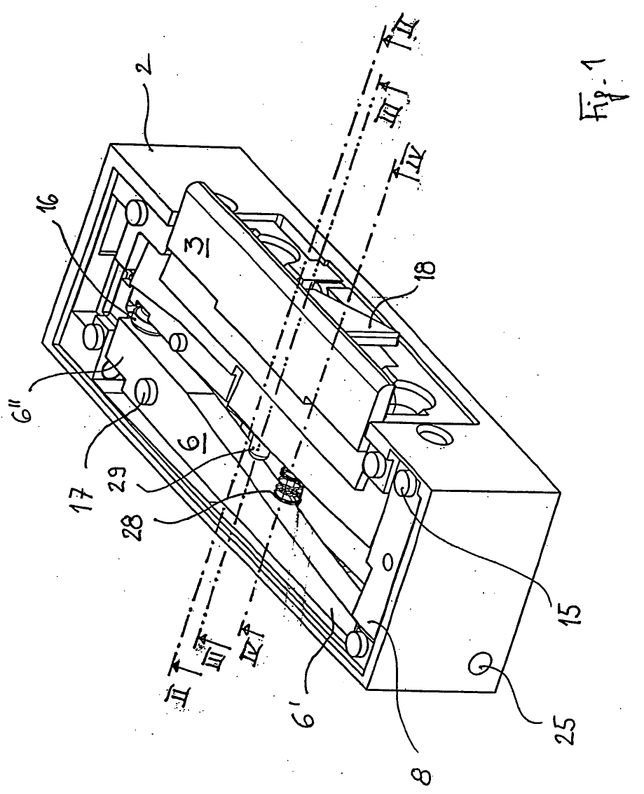

FIG. 1 shows a perspective diagonal view of a first door opener in blocking position;

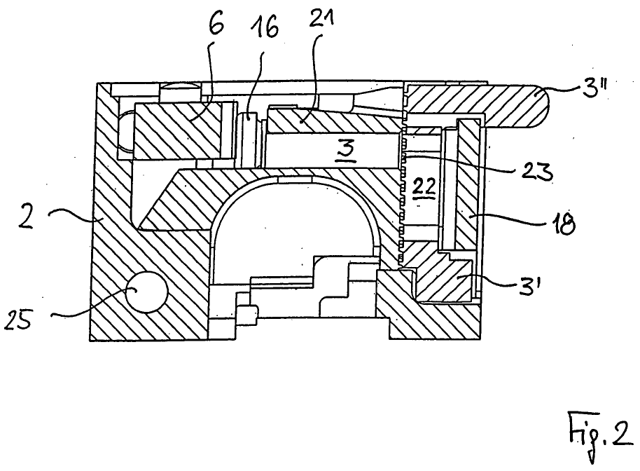

FIG. 2 shows a cross section view through the first door opener according to FIG. 1 in blocking position along line II-II;

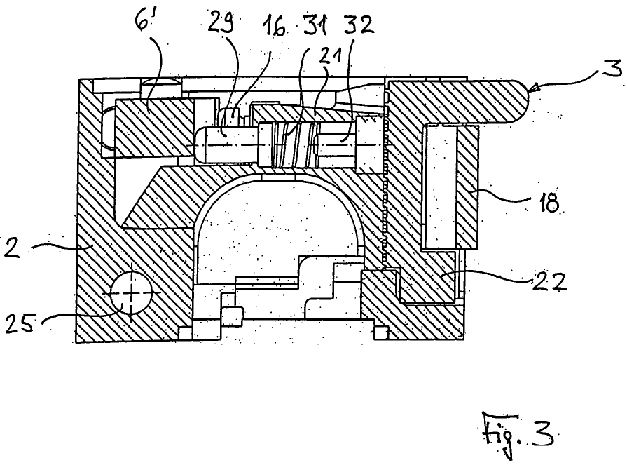

FIG. 3 shows a cross section view through the first door opener according to FIG. 1 in blocking position along line III-III;

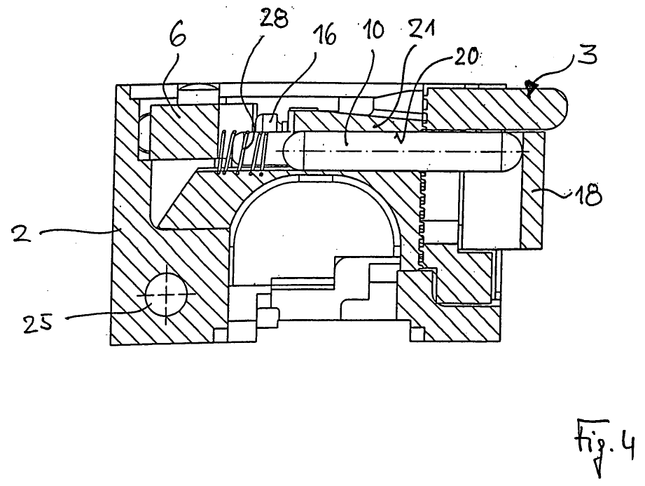

FIG. 4 shows a cross section view through the first door opener according to FIG. 1 in blocking position along line IV-IV;

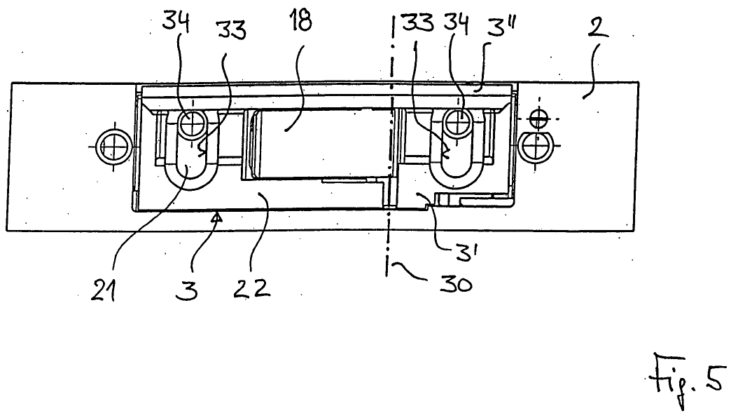

FIG. 5 shows a side view of the first door opener on the side of the lock catch;

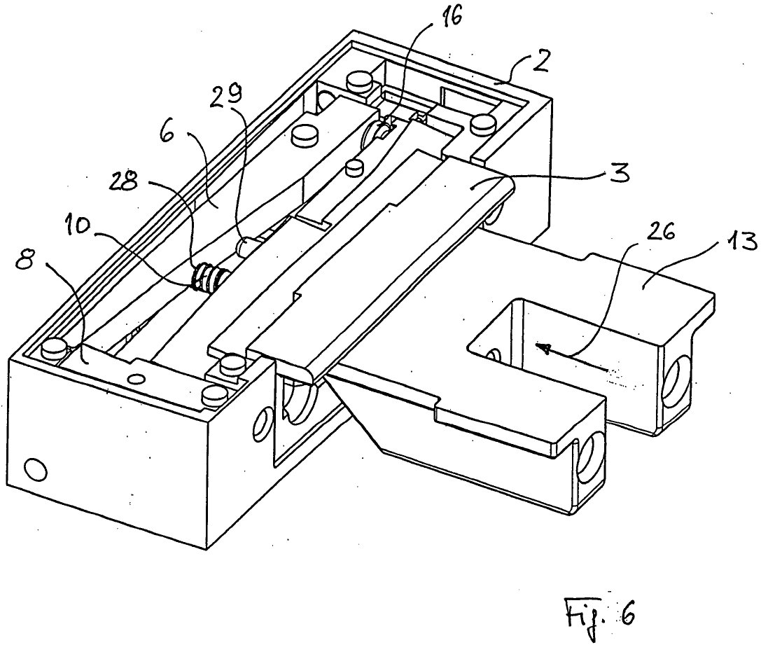

FIG. 6 shows a perspective diagonal view of the first door opener according to FIG. 1 in blocking position with a lock catch;

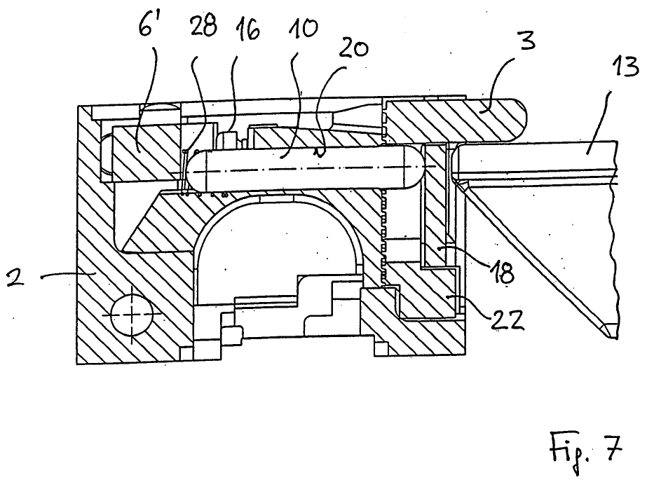

FIG. 7 shows a cross section view through the first door opener according to FIG. 2 in blocking position along line IV-IV with a lock catch;

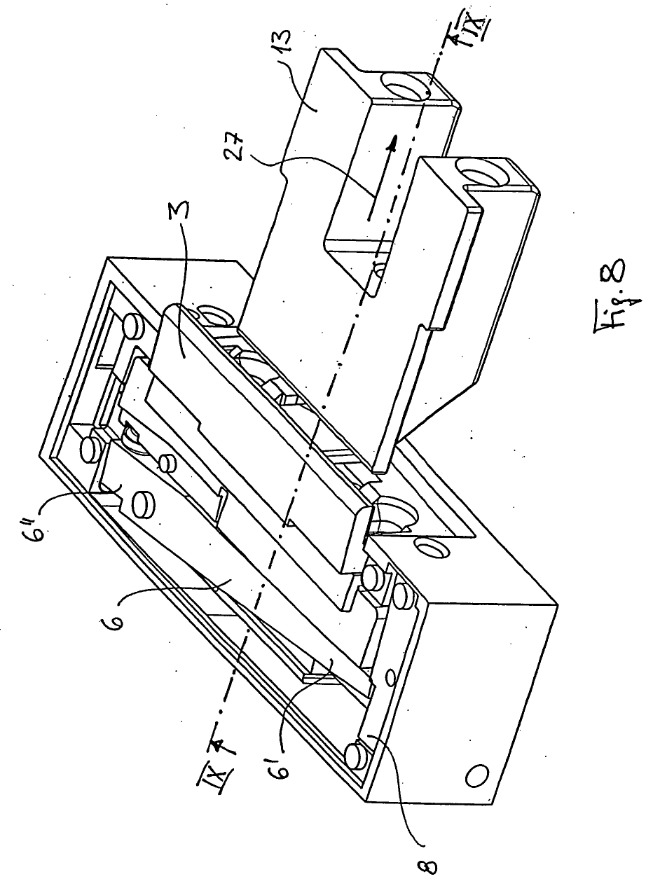

FIG. 8 shows a perspective diagonal view of the first door opener in ejected position with a lock catch;

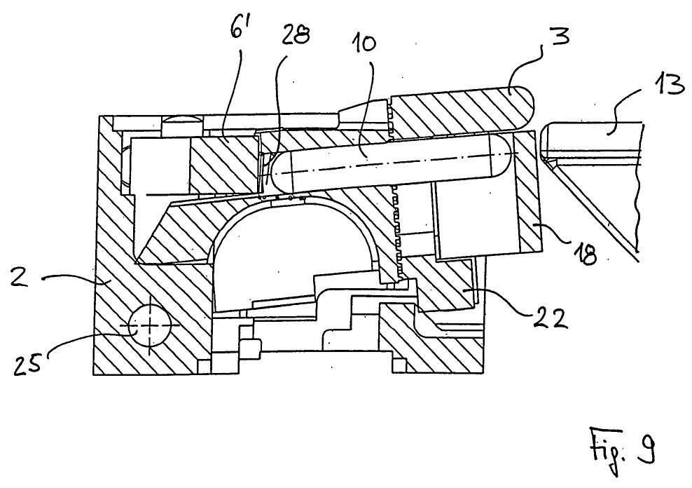

FIG. 9 shows a cross section view through the first door opener according to FIG. 8 in ejected position along the line IX-IX with a lock catch;

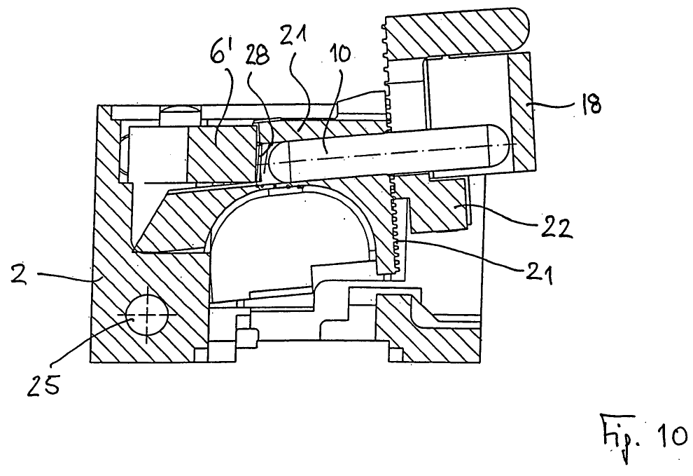

FIG. 10 shows a cross section view through the first door opener according to FIG. 9 in ejected position along line IX-IX with a swivel catch moved in comparison to FIG. 9 and without a lock catch;

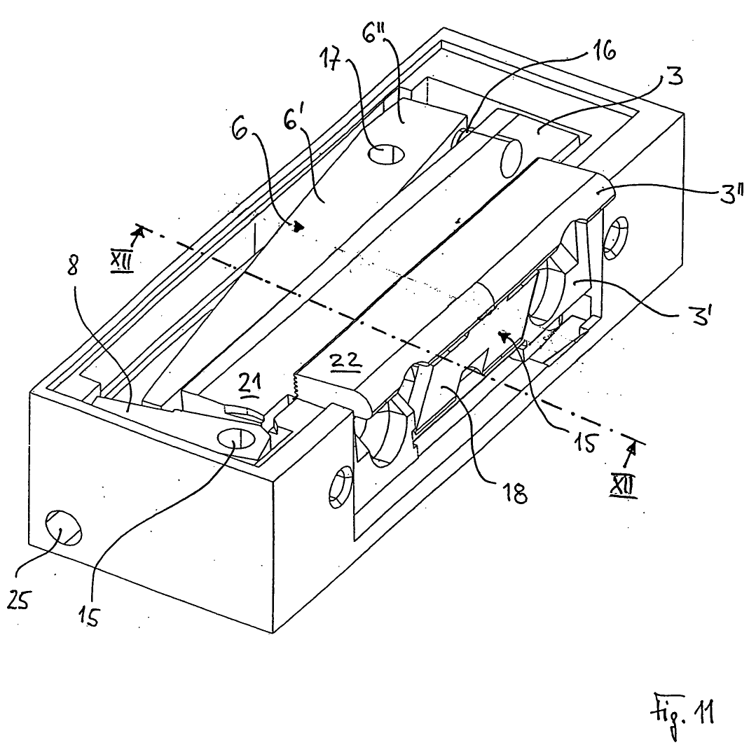

FIG. 11 shows a perspective diagonal view of a second door opener in ejected position without a lock catch; and

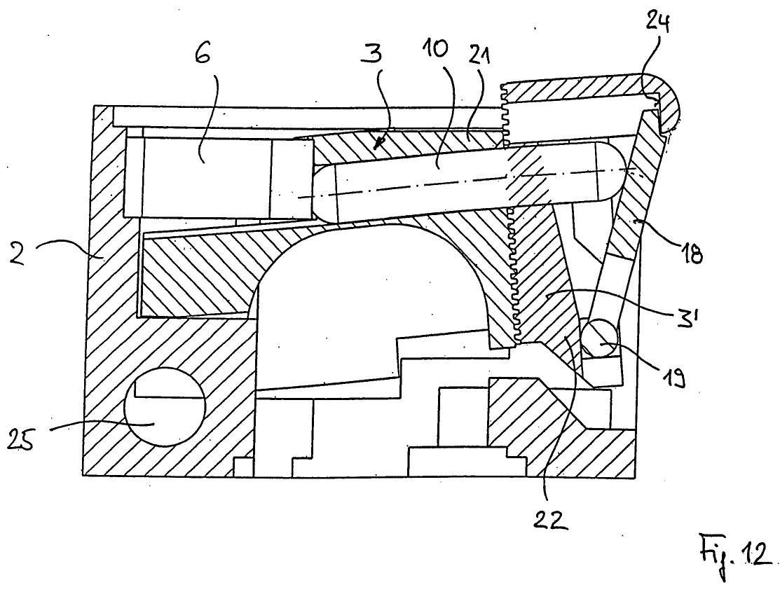

FIG. 12 shows a cross section view through the second door opener according to FIG. 11 in ejected position along line XII-XII

FIGS. 1 to 4 show a door opener in unstressed locking position. It is provided with a housing 2, a lock catch counterpart designed as a swivel catch 3, a two-armed, swivel-mounted change-over 6 and a swivel-mounted security element 8. The housing is shown with the cover (not shown) taken off. The securing element 8 is formed by an armature that is actuated directly or indirectly by an electromagnet actuator (not shown) and acts on the free end of the long lever arm 6′ of the change-over 6. The swivel axis 15 of the securing element 8 runs parallel to the swivel axis 17 of the change-over 6. The swivel axis 25 of the swivel catch is aligned perpendicular to it.

A short lever arm 6″ of the change-over 6 is in active connection with the reverse side of the swivel catch 3 in such a way that the swivel catch 3 according to FIG. 1 is prevented from movement with blocked change-over 6, i.e. the door opener is blocked. With unblocked change-over 6 according to FIG. 9, the swivel catch 3 can be swiveled against the deflecting short lever arm 6″ of the change-over 6 and the door opener is thus in ejected position.

The door opener also has an ejector for a lock catch 13 (FIG. 6), which has a slide plate 18 and a pin 10 (FIG. 4) for controlling the slide plate 18. The slide plate 18 is swivel-mounted on the swivel catch 3, whereby its swivel axis 30 (FIG. 5) runs perpendicular to the swivel axis 25 of the swivel catch 3. The slide plate 18 is prestressed by a first pressure spring 28 in connection with the pin 10. The effect of the pressure spring 28 is that in unloaded state, the slide plate 18 is swiveled into its outer position by the swivel catch 3, as shown in FIG. 1.

In the position according to FIG. 1, the securing element 8 is deflected, so that it is locking, in front of the long arm 6′ of the change-over 6 lying in its blocking position. In this process, the long arm 6′ is swiveled away from the swivel catch and the short arm 6″ lies, blocking, on the swivel catch 3. The contact between the short arm 6″ and the swivel catch 3 is implemented by a pressure piece 16, which in the example shown is mounted on the swivel catch 3. The pressure piece 16 is designed so that it is adjustable, for example using a screw thread. By sliding along the short lever arm 6″, e.g. by an eccentrically adjustable pressure point, a calibration of the contact point and/or the adjustment of the triggering force for the swivel catch 3 can be carried out. A set bolt 29, in combination with pressure piece 16, is used to adjust a triggering force for swivel catch 3.

FIGS. 2 to 4 show in detail that the swivel catch 3 is designed in two parts with a base part 21 on the mounting side and an L-shaped front part 22. The front part has a shank 3′ on the base mounting side and, on its free end, a projecting shank 3″ that serves as a stop, in the way of a tab, for a lock catch 13 (FIG. 6). The L-shaped front part 22 can be fastened optionally in different positions along the base-side shank 3′, e.g. using a latching tooth surface 23. In this way, the front part 22 can be offset in the swivel direction and arranged on the base part 21 in order to precisely adapt the engagement of the free shank 3″ with a lock catch at the position of the lock catch. The slide plate 18 is arranged on the front part 22 so that its relative position to the projecting shank 3′ is independent of the assignment of the front part 22 to the base part 21.

According to FIG. 3, the set bolt 29 is mounted in the base part 21 so that it can slide. It is stressed against the long arm 6′ of the change-over 6 with a first pressure spring 31 that is arranged in a recess of base part 21. The base point of the first pressure spring 31 lies on a set screw 32, by which the prestress between the swivel catch 3 and the long arm 6′ can be adjusted.

According to FIG. 4, pin 10 is mounted in a hole in the base part 21, so that it can slide between the long arm 6′ of the change-over 6 and the reverse side of the slide plate 18. The pin 10 is shorter than the distance involved between the long lever arm 6′ and the slide plate 18 in its outer position. The remaining difference is essentially bridged by a second pressure spring 28 that supports itself on the long lever arm 6′ and the pin presses on the slide plate 18 so that in unstressed state it assumes its outer position.

The cross section illustrations in FIGS. 3 and 4 show that the pin 10 is mounted so that it can slide lengthwise in a guide hole 20 in the swivel catch 3. The pin thus participates in every swivel movement of the swivel catch 3. FIG. 5 shows the optionally adjustable connection of front part 22 and base part 21 of the swivel catch 3 by means of parallel slots 33 in the front part and tightening screws 34 on the base part 21.

FIGS. 6 and 7 further illustrate the blocking position of the door opener described above in that a lock catch 13 of a door (not shown ) that is spring-prestressed along its lengthwise axis according to arrow 26 is shown, which engages in swivel catch 3. The lock catch 13 has pressed the slide plate 18 into its inner position at the swivel catch 3. Pin 10 is slid here against the second pressure spring 28 up to the blocked swivel latch 3. In this process, pin 10 is pushed against the second pressure spring 28 up to the blocked swivel catch, whereby the second pressure spring 28 is in its maximum compression state. The engagement of the lock catch 13 with the swivel catch 3 occurs noiselessly because of the spring effect.

Since the slide plate 18 is mounted on the front part 22, it is ensured that the slide plate always has the precise alignment relative to the lock catch 13 in every position of the front part 22, so that the engagement of the slide plate 18 with the lock catch 13 is reliably ensured. The arrangement of the pin 10 and the guide hole is selected in such a way that the pin 10 stresses the slide plate 18 in every position of the front part 22.

In the ejected position of the door opener according to FIGS. 8 and 9, the securing element 8 releases the long arm 6′. Because of the pressure of the lock catch 13 out of the drawing plane, the swivel catch 3 is pushed backward and has deflected the short arm 6″ backward. As a consequence, the long arm 6′ is deflected forward toward the reverse side of the swivel catch 3.

The long arm 6′ slides the pin 10 against the reverse side of the slide plate 18 and deflects it forward from the outer position shown in FIG. 1, whereby the second pressure spring 28 maintains its compressed state and thus the spring action of the second pressure spring 28 is eliminated. In this process, the lock catch 13 is slid back in arrow direction 27, opposite its spring force and goes out of engagement with the swivel catch 3. The change-over 6 thus has the function of a mechanical force-path transfer element. The two ends of the pin 10 are rounded so that it can slide lightly along the change-over 6 and the slide plate 18 when a sliding movement is carried out.

In summary, the door opener works as follows. If the change-over 6 is electromechanically released, a force exercised by the lock catch 13 on the front part 22 has the effect that the swivel catch 3 is deflected around its swivel axis 25 in force direction. The force is reversed by the swivel catch 3 and transferred to the change-over, which pushes the slide plate 18 by way of the pin. In this way, during the swiveling of the swivel catch 3, the pin 10 moves relative to the swivel catch 3 and in this process acts on the slide plate 18. This slides the lock catch 13 past the free end shank 3″ of swivel catch 3, which is simultaneously moved laterally out of the path of the lock catch 13, which this runs through during the opening movement of the door involved.

Overall then, the force exercised in swivel direction by the lock catch 13 on the swivel catch 3 by way of lever mechanics serving as a force transmission element is reversed about 90° and a force-path conversion occurs, as a result of which the lock catch 13 is pushed back, perpendicular to the swivel direction, into its open position. The release of lock catch 13 thus is based, on one hand, on the lateral swiveling of the swivel catch 3 from the lock catch 13, and on the other by the sliding of the lock catch 13 away from the lock catch 3. The release of the lock catch 13 from the swivel catch is no longer exclusively due to a swivel movement of the swivel catch 3 as in known door openers, but completed due to a combined swivel-sliding movement of swivel catch 3 and ejector. This permits a small swivel distance of swivel catch 3. Therefore, it can have a relatively long swivel arm, so that the swivel bearing 25 can be mounted, as shown, in the area of the housing corner, which is opposite the free end of the swivel catch 3. The length of the swivel lever of the swivel catch 3 can thus correspond to approximately the depth of the housing.

In connection with the L-shaped front part 22, FIGS. 1 to 9 differ on one hand, and FIG. 10 on the other by their position on the base part 21. As FIGS. 1 to 9 show, the front part 22 is arranged on the latching tooth surface 23 in its inner position in which the door opener has its smallest depth. According to FIG. 10, the front part 22 is in a position that is slid outward. The latching tool surface, in connection with the slots 33 and the set screws 34, permit a precise adaptation of the front part 22 to the position of the lock catch 3 for different installation conditions of the door opener.

Since the slide plate 18 is arranged on the front part 22, it is ensured that the slide plate 22 also has the precise alignment relative to the lock catch in every position of the front part 22, so that the engagement of the slide plate 18 with the lock catch is reliably ensured. The arrangement of the pin 10 and the guide hole 20 is selected here in such a way that the pin 10 stresses the slide plate 18 in every position of the front part 22. In this case, the lever arm is also equal in every position of the front part 22, in which the pin 10 engages the slide plate 18. Because of this, the triggering force of the door opener is independent of the position of the front part 22.

In the second door opener according to FIGS. 11 and 12, parts that are the same as those in the first door opener are indicated with the same reference characters so that reference is made to the description above. Function and interaction match those of the first door opener. The second door opener differs from the first door opener only by the arrangement of the slide plate 28, which in this case is arranged with its swivel axis parallel to the swivel axis 25 of the swivel catch 3. The free end of the slide plate is assigned to the free shank 3″ in this case.

The cross section illustration in FIG. 12 also shows that the free shank 3″ of the swivel catch 3 has an inner edge 24 that serves as a stop for the slide plate 18 and on which the free end of the slide plate 18 supports itself when it is swiveled out.

Alternatively to the swivel catch, it can be advantageous to design the lock catch counterpart as a sliding catch, preferably as a linear sliding catch.

1. Door opener for releasing a door, which is provided with a lock catch counterpart and with a controllable securing element to secure the door opener against unauthorized opening of the door,
characterized in that it is provided with an ejector for ejecting the lock catch from the lock catch counterpart and with a transmission element between the lock catch counterpart and the ejector, with which the force initiated by the lock is transferred to the ejector.

2. Door opener according to claim 1, characterized in that the ejector is mounted on the lock catch counterpart.

3. Door opener according to claim 2, characterized in that the ejector comprises a slide plate that is mounted on the lock catch counterpart so that it can swivel.

4. Door opener according to claim 3, characterized in that the swivel axis of the slide plate runs parallel to the movement direction of the lock catch counterpart.

5. Door opener according to claim 4, characterized in that the lock catch counterpart is designed as a swivel catch and that the swivel axis of the slide plate runs perpendicular to the axis of the swivel catch.

6. Door opener according to claim 4, characterized in that the lock catch counterpart is designed as a sliding catch, especially a linear sliding catch.

7. Door opener according to claim 3, characterized in that the transmission element comprises a lever connection with a controlled two-armed change-over, that one lever arm serves as a locking element for the lock catch counterpart and that the other lever arm is in active connection with a pin that engages with the slide plate.

8. Door opener according to claim 1, characterized in that the two-armed change-over is controlled piezo-electrically, magneto-restrictively, using shape-memory actuators, mechanically, using rheological fluids, hydraulically, pneumatically or with a combination of these methods.

9. Door opener according to claim 1, characterized in that the transfer element is designed as a Bowden cable, multi-link transmission, pushing element chain or hydraulic system.

10. Door opener according to claim 1, characterized in that a front part of the lock catch counterpart can be adjusted relative to a base part.

11. Door opener according to claim 1, characterized in that the transfer element is prestressed with a prestress element.

12. Door opener according to claim 1, characterized in that another prestress element is provided to adjust the triggering force.

13. Door opener according to claim 1, characterized in that a pressure piece is provided between the swivel catch and change-over for calibrating purposes.

14. Door opener according to claim 1, characterized in that a closed door opener closing plate is provided.

15. Door opener according to claim 1, characterized in that a roller element is provided on the lock catch counterpart in the contact area of the lock catch.
